(19) United States
(12) Patent Application Publication
(10) Pub. No.: US 2006/0011849 A1
(43) Pub. Date: Jan. 19, 2006

(54) Gate monitoring system and method for instant gamma analysis

(75) Inventors: Hsun-Hua Tseng, Lun Tang (TW); Tin-Yu Liau, Chu Tung (TW)

Correspondence Address: DENNISON, SCHULTZ, DOUGHERTY;& MACDONALD, SUITE 105, 1727 KING STREET, ALEXANDRIA, VA, 22314-2700, US

(73) Assignee: INSTITUTE OF NUCLEAR ENERGY RESEARCH, ATOMIC ENERGY COUNCIL

(21) Appl. No.: 10/889,023

(22) Filed: Jul. 13, 2004

(51) Int. Cl. G01T 1/20

(52) U.S. Cl. 250/367

(57) ABSTRACT

A gate radiation monitoring system and method for instant gamma analysis on passing by objects is related to two photomultiplier tubes respectively installed at the two ends of the column plastic scintillation detectors. By use of precise high frequency clock with period about 10 nsec, the analog pulse signals from the all photomultiplier tubes which respond the ionizing gamma events of the plastic scintillation detectors can be converted into logic signals by the discrimination circuit. The continuous timing records can be built in sync. for all PMTs by personal computer. It has been proved that through the present invention, conventional gate detector can be applied to quick determination of the surface radiation intensity, the energy and location of the gamma emitters contained in the detected objects.

### BACKGROUND OF THE INVENTION

1. Field of the Invention

The present invention relates to a gate or portal radiation monitoring system and method for instantly analyzing constituent gamma nuclides and their distributions of any radioactive subject passing through it, which is used in radiation workplace for the radiological control of pedestrians, persons, vehicles, trucks and rail cars.

2. Description of the Prior Art

Either of neglect or with intent, leaking out of radioactive materials usually happens via persons, cars, and wastes in the radioactive work place. Sometimes it would bring out tremendous environmental and social costs. Therefore, measures should be taken to prevent the proliferation of radioactive materials. Among them, portal monitors at entrance or exit to watch every passing subject for instant discrimination of radioactive materials is widespread used. Considering the quality demands such as heat-resistance and impact-resistance, reliability, sensitivity, and maximum coverage . . . etc., almost all of commercially available products select column plastic scintillation detector made of low density polyvinyltoluene with single-ended photomultiplier tube (PMT) for flicker signal pickup. Unlike its high density counterparts such as germanium and sodium iodide scintillation detectors, the primary drawback of low density plastic is that it can measure only intensity but not energy and distribution information on subject's radioactivity.

### SUMMARY OF THE INVENTION

The primary object of the present invention is to provide a plastic detector gate or portal radiation monitoring system and method for being capable of instantly analyzing constituent gamma nuclides and their distributions of any radioactive subject passing through it. The technical means according to the present invention principally uses a precise high frequency clock continuous timing to replace simple event counting method upon radiation pulse signals. Moreover, an additional PMT is attached to the other end of column plastic scintillation detector with its signal be handled by timing process simultaneously.

The present invention has two focal points. One is two end PMTs are used for each column plastic detector for coincident pulse analysis at the same time. The other is the signal processing technique. Every pulse signal out from PMT is firstly converted to the logic pulse through pulse discrimination amplifier, then transmitted to the computer controlled counting electronics to build absolute timing record using buffered semi-period timing method. Finally the timing information of pulse coincidence, distance and width of all detector photomultiplier tubes can be extracted from their respective absolute timing records by computer data analysis.

By referring to the accompanying drawings, the embodiment of the system and method according to the present invention and its principle are in detail described as follows:

### BRIEF DESCRIPTION OF THE DRAWINGS

FIG. 1 is a schematic view of the long column shape plastic scintillation detector of the present invention, wherein (101) represents plastic scintillation detector; (102) represents two end PMTs; (103) represents light photons emitted from the plastic molecules excited by incident γ particles; (104) represents incident γ particle; (105) represents the electrons emitting from photocathode of PMT due to scintillation photons; (106) represents the multi-stage dynodes for the multiplication of the photo electrons

FIG. 2 is a diagram of a circuit for processing pulse signals from PMT of the present invention, wherein (201) represents the high voltage supply to PMT; (202) represents conditioning circuit for amplifying and shaping PMT pulses; (203) represents the shaped PMT pulse signal; (204) represents the pulse height discrimination circuit for noise filtering and converting PMT signal to logic pulse; (205) represents the logic pulse with width characteristic of absorbed energy; (206) represents the driving circuit for long distance (up to 1 km) transmission of logic pulses;

FIG. 3 is a diagram of timing circuit with high precision clock of the present invention: (301) represents the high frequency precision clock as the source input to the counter; (302) represents the PMT logic pulse as the gate input to the counter; (303) illustrate the operation principle of buffered semi-period timing by counter use high precision clock; (304) represents the buffer memory for sequentially storing the timing data every semi-period; (305) represents the computer for data retrieve and analysis;

FIG. 4 is a diagram for theoretical fitting of experimental pulse signal waveforms according to the present invention;

FIG. 5 is a diagram on the experimental relationship between PMT pulse height and logic pulse width which can be described by a semi-empirical formula;

FIG. 6 is a diagram of experimental and theoretical statistics of pulse interval in terms of Poisson Distribution function as described in formula (3);

FIG. 7 is a diagram showing the mean pulse interval of plastic scintillation detector will reach a steady value when sample number is increased;

FIG. 8 is a schematic diagram on gate detection system of the present invention, wherein (801) represents two dual-PMT plastic detector columns; (802) represents a passing-by subject being detected; (803) represents radioactive source contained within the subject;

FIG. 9 is a schematic diagram showing the detection angles of coverage to a point radioactive source of plastic detectors at XY plane for the gate detection system according to the present invention;

FIG. 10 is a diagram showing the pulse counting rate ratio variations along Z axis of two end PMTs (named A and B, respectively), for three different gamma sources laid right on the central detector surface;

FIG. 11 is a diagram showing the pulse counting rate ratio variations along Z axis of two end PMTs (named A and B, respectively), for Cs-137 (662 keV) gamma source laid on three different X distances away from central detector surface;

FIG. 12 is a diagram showing the pulse counting rate ratio variations along Z axis of two end PMTs (named A and B, respectively), for Cs-137 (662 keV) gamma source laid on three different Y distances away from central detector surface;

FIG. 13 is a diagram showing PMT A's (at right hand) relative pulse width distribution characteristics of Co-60 (1.25 MeV) gamma source laid on central detector surface with three different Z positions;

FIG. 14 is a diagram showing PMT A's (at right hand) relative pulse width distribution characteristics of Cs-137 (662 keV) gamma source laid on central detector surface with three different Z positions;

FIG. 15 is a diagram showing PMT A's (at right hand) relative pulse width distribution characteristics of Am-241 (60 keV) gamma source laid on central detector surface with three different Z positions;

FIG. 16 is a diagram showing the probability function of pulse coincidence between two end PMTs of plastic scintillation detector for Co-60 gamma source laid on central detector surface with three different Z positions;

FIG. 17 is a diagram showing the probability function of pulse coincidence between two end PMTs of plastic scintillation detector for Cs-137 gamma source laid on central detector surface with three different Z positions;

FIG. 18 is a diagram showing the probability function of pulse coincidence between two end PMTs of plastic scintillation detector for Am-241 gamma source laid on central detector surface with three different Z positions; and

FIG. 19 is a flowchart of main controller program for the gate monitoring system of the embodiment according to the present invention.

### DETAILED DESCRIPTION OF THE PREFERRED EMBODIMENT

Design Consideration of the Plastic Scintillation Detector

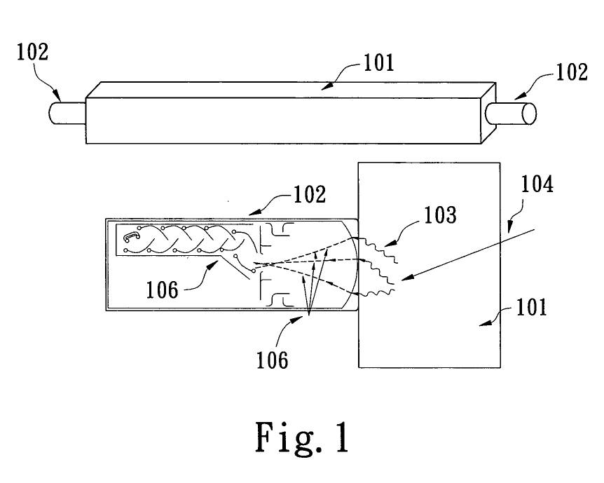

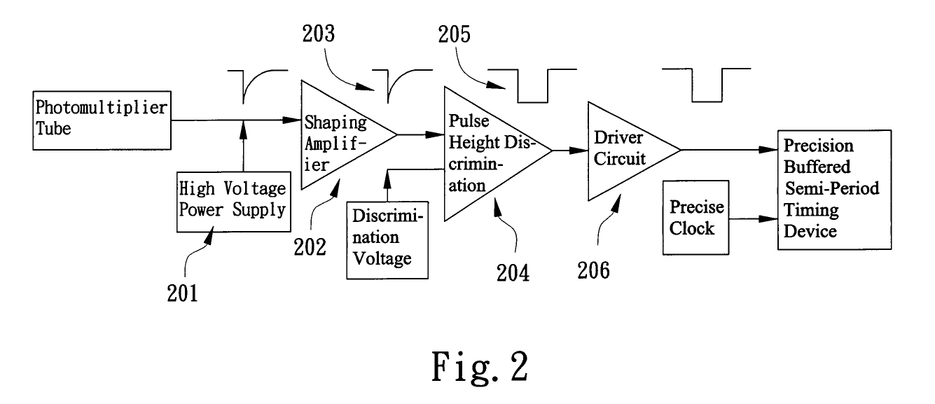

The structure of the radiation detector used for the present invention is shown in FIG. 1. There are two PMTs (102) installed at both ends of the conventional column plastic scintillation detector (101). The energy of incident γ particle (104) is transferred to the π electron of the plastic molecules. The π electron jumps to the excited state, then returns to the steady state and emits a photon (103). When the photon is collected by the cathode of the PMT, there are about 10⁷˜10¹⁰ photoelectrons (105) being produced due to the photoelectric effect. The number of the electrons can be multiplied up to 10⁶ times by impacting cascaded dynodes (106). Thus, photoelectric current (about 20-50 nsec) transient can produce a voltage pulse in external circuit, which height is proportional to the absorbed energy of the γ particle. Both type and strength of the gamma radiation field can be obtained from the shape, height, and frequency of the signal pulse. A typical column plastic scintillation detector includes two end PMTs (e.g., type model R268 of Japanese Hamamatsu Co.) and one plastic scintillation detector with size of 13 cm wide, 120 cm long, and 5 cm thick. Its detection efficiency to cobalt 60 is about 30%. The PMTs' signal conditioning circuit is shown in FIG. 2. There is a high voltage supply (201), which can provide higher than one thousand volts to PMT for light detection. The shaping amplifier circuit (202) can amplify and shape the pulse signal (203) from PMT. The pulse height discriminator circuit (204) converts the signal from the shaping amplifier circuit (202) to the logic pulse (205). Long distance transmission of logic pulse can be achieved by driving circuit (206). The time stamps of occurrence, arriving interval, and width of the logic pulses can be measured and used to determine the type, location, and strength of detected gamma radiation.

The Continuous Buffered Semi-Period Timing Method

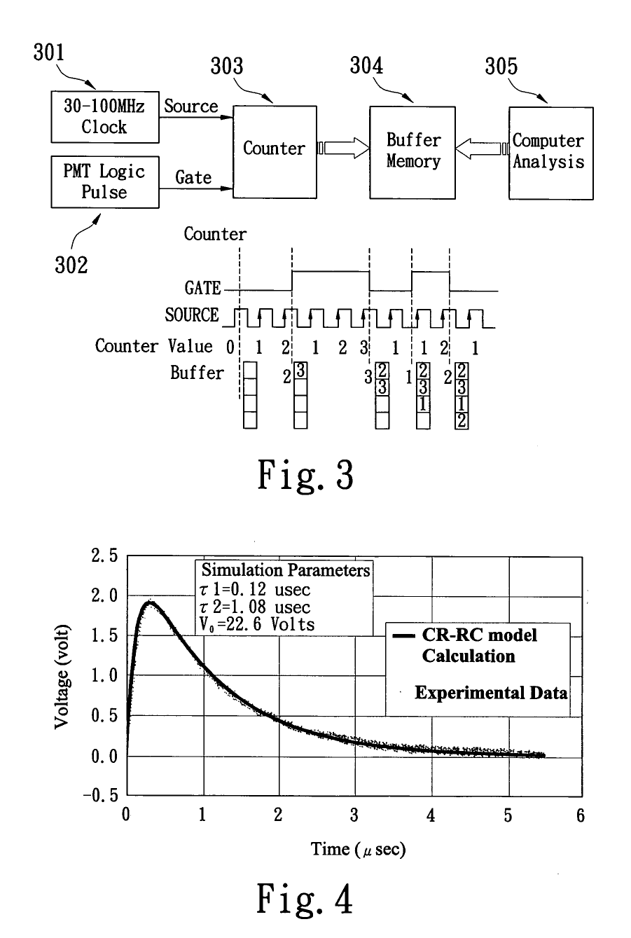

Unlike the prior method of simple pulse counting, the present invention uses continuous buffered semi-period timing method to study logic pulses generated by the circuit shown in FIG. 2. Counter setup for high precision timing is shown in FIG. 3. The source input of the counter (303) is high frequency (say, 80 MHz) clock (301) and the logic pulse (302) from detector is sent to gate input. At each logic transition of gate signal, the total counts of positive clock pulses since last transition is stored to buffer memory (304) in sequence. After a certain acquisition time or a preset number of logic pulses, all buffered timing data are transferred to the computer (305) for calculation and analysis. If the detector pulse is negative logic as shown in FIG. 3, the 3rd, 5th, and 7th . . . data are the width of the logic pulse signal measured with clock, and the sum of 3+4, 5+6, 7+8 . . . are the time interval of the radiation events. Because all counters are armed simultaneously, coincidence of two radiation events can be easily identified by direct comparisons of time records of different PMTs. Therefore, statistics on time intervals, pulse width, and coincidence can be obtained from the buffered semi-period timing data. The method to create new function by utilizing time records of plastic scintillation detectors is described as follows.

Correlation Between the Logic Pulse Width and the Analog Pulse Height

As shown in FIG. 2, the analog voltage pulses from PMT are amplified and shaped by the signal conditioning circuit and then converted into the logic pulses by the discriminator circuit. To get the mathematical relationships, a large number of shaped analog voltage pulse at the input and logic outputs of the discriminator circuit are measured and recorded by the digital oscilloscope. For all analog voltage pulses, their waveform can be fitted to the following function:

$${V}_{( t )} = {V}_{0} \times ( \frac{{τ}_{1}}{{τ}_{1} - {τ}_{2}} ) ( {ⅇ}^{- t / {τ}_{1}} - {ⅇ}^{- t / {τ}_{2}} ) \qquad ( 1 )$$

where, V(t) is time waveform function of analog voltage pulse and V₀, time constants τ₁ and τ₂ are physical parameters determined by detection and circuit characteristics. As shown in FIG. 4, the measured waveform is well fitted to the results obtained by model calculations. When we have proved that all voltage pulses with different amplitudes can be described by equation (1), the relation between the height (Vₚ) of analog voltage pulse and the width (T_{w}) of logic pulse is determined as:
Vₚ=V₀×e^{T}^{_{w}}^{/τ}+V₁ (2)
where, V₀, V₁ are fitting parameters and the time constant τ can be derived from equation (1). In our case, τ≈τ₁ whenever τ₁>>τ₂.

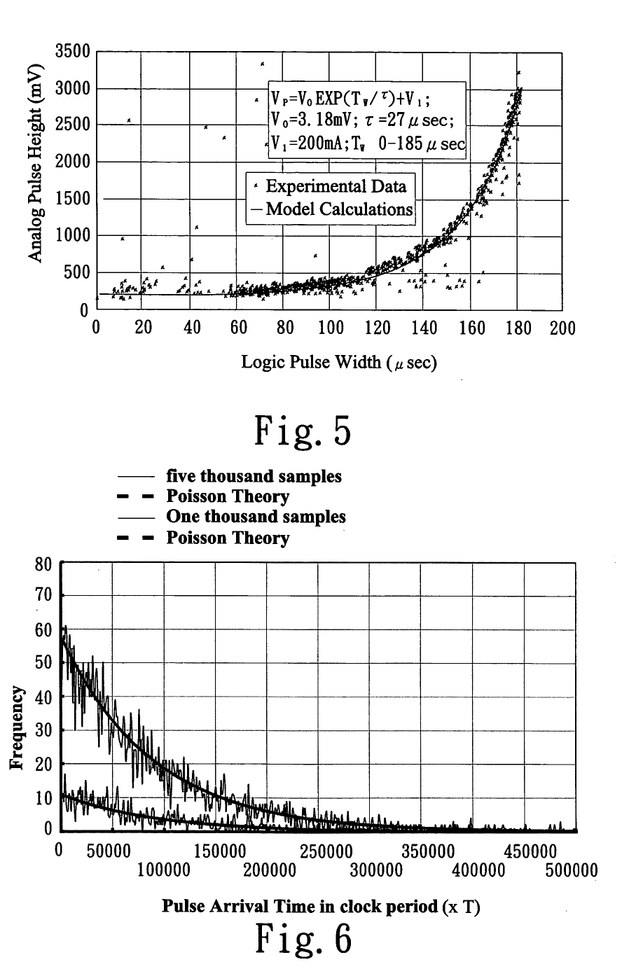

As shown in FIG. 5, the measured results (small crosses) are well fitted to the results obtained by model calculations (solid curve). If the period of the high frequency clock is T_{CIK}, we also find out that the calculated analog pulse height from the logic pulse width according to equation (2) has a relative precision determined by the period (T_{CIK}) of the clock and the time constant τ as shown in formula (3). This property is quite different from the absolute precision in prior analog/digital conversion (e.g., no matter what the pulse height is, the precision of measurement is always 1 mv) where we are deemed to poor resolution for low energy gamma photons. This property is rather compliant to the physics on the energy resolution of most conventional scintillation detectors.

$$\frac{{dV}_{p}}{{V}_{P}} = \frac{{dT}_{w}}{τ} = \frac{{T}_{CIK}}{τ} \qquad ( 3 )$$

Correlation Between Pulse Counting Rate and Time Interval of Radiation Pulses

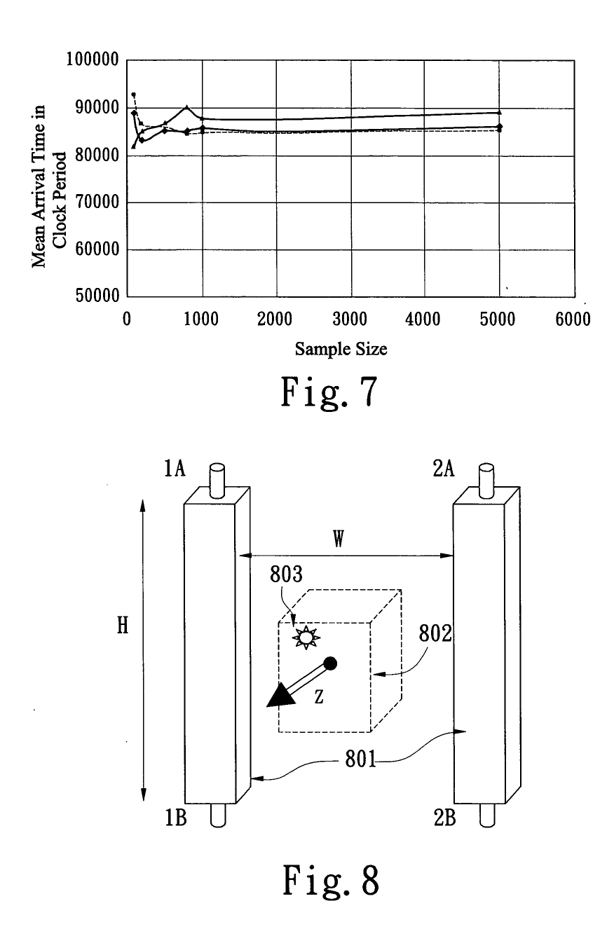

In addition to the energy obtained from digital pulse width, the pulse rate can also be derived from statistics on time interval between neighboring radiation pulses. Whatever kind of detector in used, because the radiation events is a stochastic process, the statistics on arrival time of radiation pulses should obey the Poisson distribution function as follows:
I₁(t)dt=t×e^{-t/t}dt (4)
wherein I₁(t) is the number of radiation events between t and t+dt, [symbol] t [symbol] is the mean time interval between radiation events and its reciprocal is the count rate of pulses measured. FIG. 6 shows two statistical distributions of the pulse arrival time with different sample size. It is observed that the statistics obey Poisson Process within reasonable accuracy. FIG. 7 shows the mean arrival time of radiation pulses as function of sample number. We can see that when the sample number is increased to 500, the mean arrival time will reach a steady state value within ±5%. Therefore, we may get a fairly good estimation of the pulse counting rate when there are 500 pulses have been received.
Methods to Identify Gamma nuclides by Plastic Scintillation Detector

FIG. 8 is a schematic view showing the gate monitoring system with two dual-PMT column plastic scintillation detectors (801), which are in parallel arranged. By buffered semi-period timing technique, there are four statistical time records about the count rate, signal width, and event coincidence that can be obtained for four PMTs (1A, 1B, 1A, 2B). We can make a smart use of them to estimate the type and distribution about the radioactive portion (803) of the contaminated subject (802). Among the most popular artificial radioactive nuclides hidden within measured objects are Cₒ-60 (1.25 Mev), Cₛ-137 (662 Kev), or Aₘ-241 (60 Kev). Therefore, we will give our focus on these three nuclides. However, more complicated condition can also be treated by the present invention if we can handle the above-mentioned nuclides. All we need is more calculation and calibration steps but with exactly the same operation principle. There are three ways to do gamma analysis:

(1) Identify Type and Location of Gamma Radiation by Pulse Counting Rate

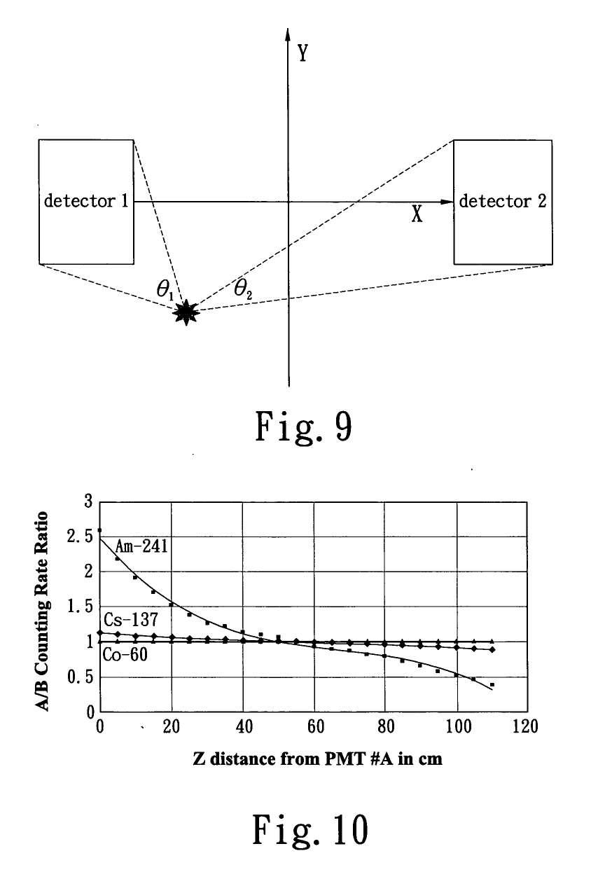

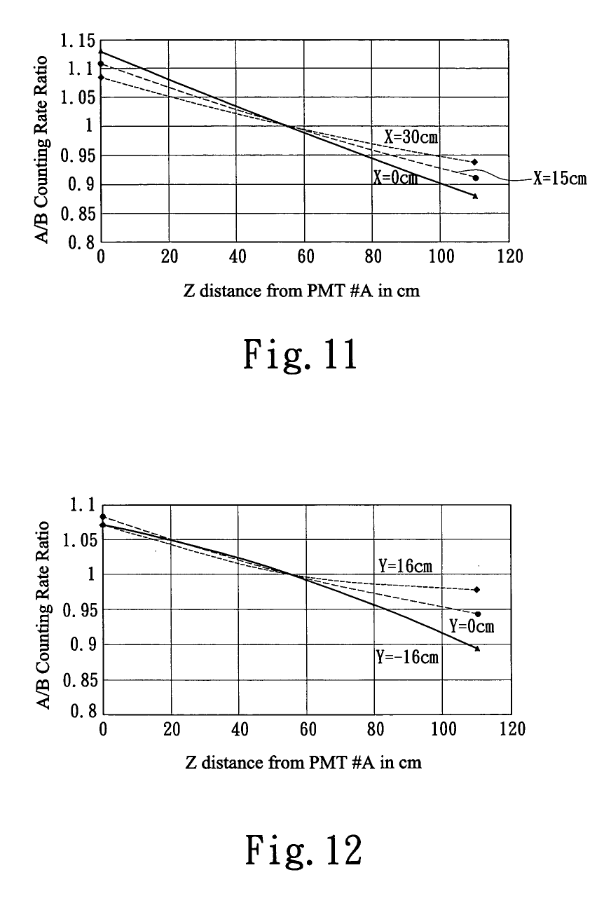

FIG. 9 is the cross section view about the coverage of detection by the parallel gate detectors of FIG. 8. It is well known that the location of a point radioactive source in FIG. 8 can be specified in terms of X (left-right), Y (front-rear), and Z (upper-lower) coordinates. The coverage angles θ₁, θ₂ on the left and right detectors by a point source locate at (X, Y) coordinate can be calculated by simple triangle functions which determine the count rate ratio of them. Because we have 4 PMTs, we may also handle the (X, Z) or (Y, Z) coordinate with exactly the same way. Therefore correlation tables can be established to get (X, Y, Z) information by calibration with different nuclides. In practice, the accuracy won't be better than ±20% due to many factors, such as energy, uniformity and shape of source, shielding effects of material being contaminated . . . etc. FIG. 10 shows the counting rate ratio of up and down PMTs as function of Z coordinate for three different nuclides laid on the surface of a single column plastic scintillation detector. It can be seen that the lower the gamma energy, the stronger dependence of count rate ratio on Z coordinate. The range of ratio variations is 2.5 to 0.4 for Am-241 (60 keV), 1.13 to 0.9 for Cₛ-137 (662 Kev), and almost constant for Cₒ-60 (1.25 Mev). FIG. 11 shows the ratio range as function of X coordinate for Cₛ-137 laid on the surface of the single column plastic scintillation detector. FIG. 12 shows the count ratio changes with Z and Y coordinates for Cₛ-137 laid at 30 cm above the surface of the single plastic scintillation detector. In summary, for the gamma nuclides with energy substantially lower than Co-60, the correlation table can be a practical way of distribution analysis. But for the nuclides with higher energy, we should find another way to solve the problem of weak dependence on Z coordinates in terms of count ratio of two end PMTs.

(2) Identify Type and Location of Gamma Radiation by Pulse Width Statistics

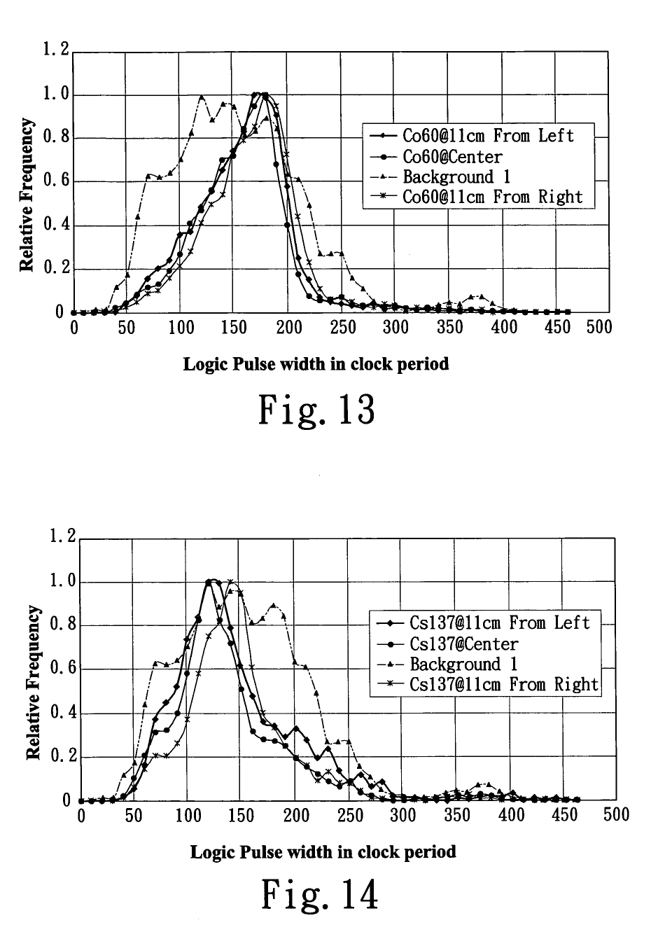

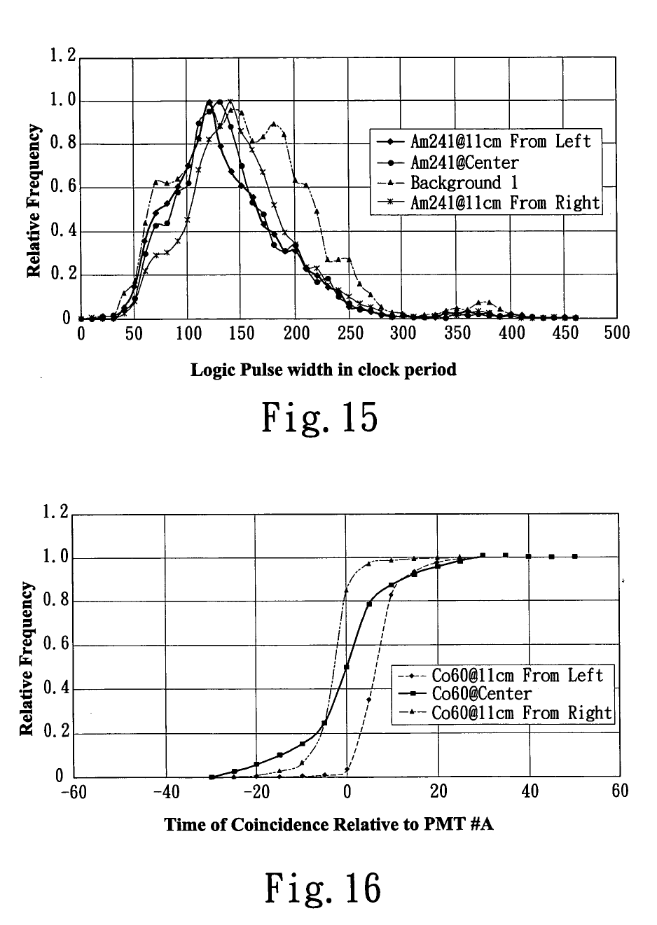

When the counting rate ratio fails to give the Z-axis information on the location of radiation source, the pulse width method could be useful. FIGS. 13-15 show the pulse width distribution as function of Z coordinate for three different radiation nuclides. According to them, the correlation between (X, Y, Z) coordinates and pulse width distributions of 4 PMTs for different artificial nuclides can be established by the calibration procedure similar to counting rate method. Both type and location of the radiation source can be derived from measured pulse width distribution from correlation table.

(3) Identify Type and Location of Gamma Radiation by Time of Coincidence

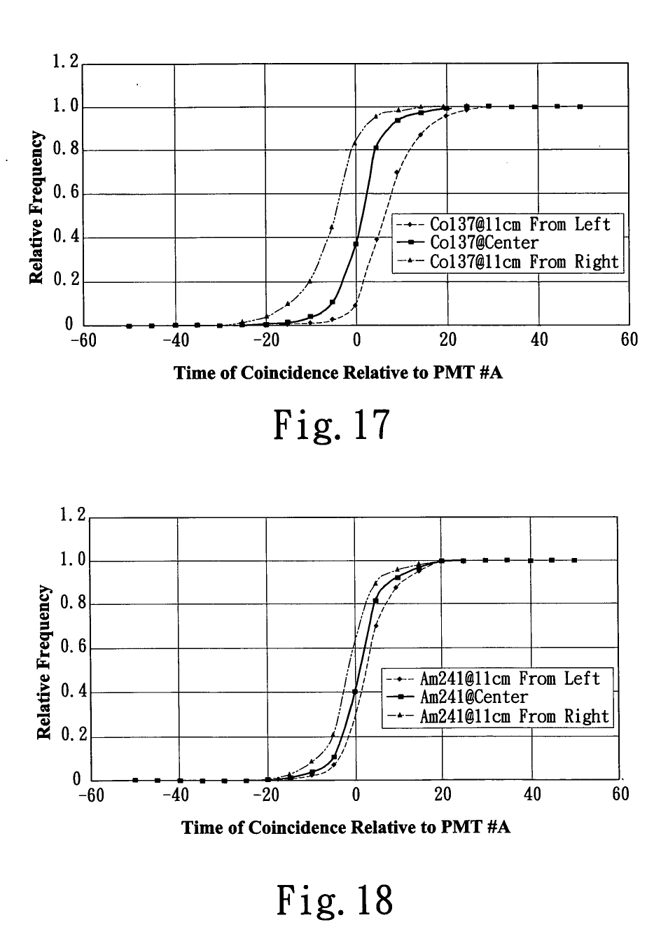

In addition to the count rate and the pulse width, the time of coincidence can also be used to estimate gamma radiation and location by means of the pulse signals from the four photomultiplier tubes of the gate detection system according to the present invention. FIGS. 16-18 show the probability function of coincidence time between pulses from two end PMTs as function of Z coordinate for three different radiation nuclides. According to them, the correlation between (X, Y, Z) coordinates and coincidence probability function of each plastic detector for different artificial nuclides can be established by the calibration procedure similar to counting rate method. The creation of coincidence probability function of each plastic detector is described as follows:
(1) For each plastic scintillation detector, the absolute timing records of two PMT signals are compared. When two pulses with leading edge come within 250 nsec, they are taken as coincident event.
(2) Taking 50 nsec as unit and calculate number of coincident pulses as function of their leading or lagging times.
(3) Integrate coincident pulse numbers, from 250 nsec lag to 250 nsec lead for pulses from two PMTs, then plot their probability functions.

Taking FIG. 16 as example, when the Cₒ-60 source is laid near to the PMT at one side, 90% of coincident pulses take leads to those of other side PMT. When the radiation source is moved to the middle, the percentage of leading drops to 50%, and will drop down to 5% if the source is moved further to other side. Similar to pulse width analysis, the percentage of leading above certain time (say, 0 nsec) can be used as the characteristic value to estimate the gamma type and location. The correlation table of (X, Y, Z) coordinates and the leading percentage for different radiation sources can be established by the calibration procedure. However, it must be noted that the coincidence of pulses can only happen between 2 PMTs of the same plastic scintillation detector for radiation source with single photon emission per decay. One exceptional case is Co-60 where there are two photons per decay. This characteristic is valuable for identifying and locating Cₒ-60 radiation sources use coincidence method.

In order to realize a gate monitoring system for instant type and location identification of gamma source, the device of the present invention includes: at least one set of detector, as shown in FIG. 8, consists of two parallel column plastic scintillation detectors with each one equipped with two end PMTs. Wherein behind each PMT they're being electronic circuitry, as shown in FIG. 2, for signal conditioning and analog/logic conversion. The working parameters of the circuitry must be set to match the detector front-end for efficient absorption and conversion within detection range of interests. There are a high voltage power supply for PMTs; a circuitry for buffered semi-period timing, as shown in FIG. 3, in which all PMT logic pulses are counted with high frequency clock for precise timing. At every up or down logic transition of PMT signal, the total counts of positive clock pulses since last transition is stored to buffer memory (304) in sequence; a main controller with built in program and peripheral hardware for data operation, input, display, and communications. After the logic pulses from all PMTs are recorded for a given time period or sample number, they are used by main controller for parametrical analysis, such as the count rates, the distribution function of pulse width and coincidence among 4 PMTs. Then, the built-in correlation tables of characteristic parameters produced by calibration are applied to derive type and the location of the radiation source.

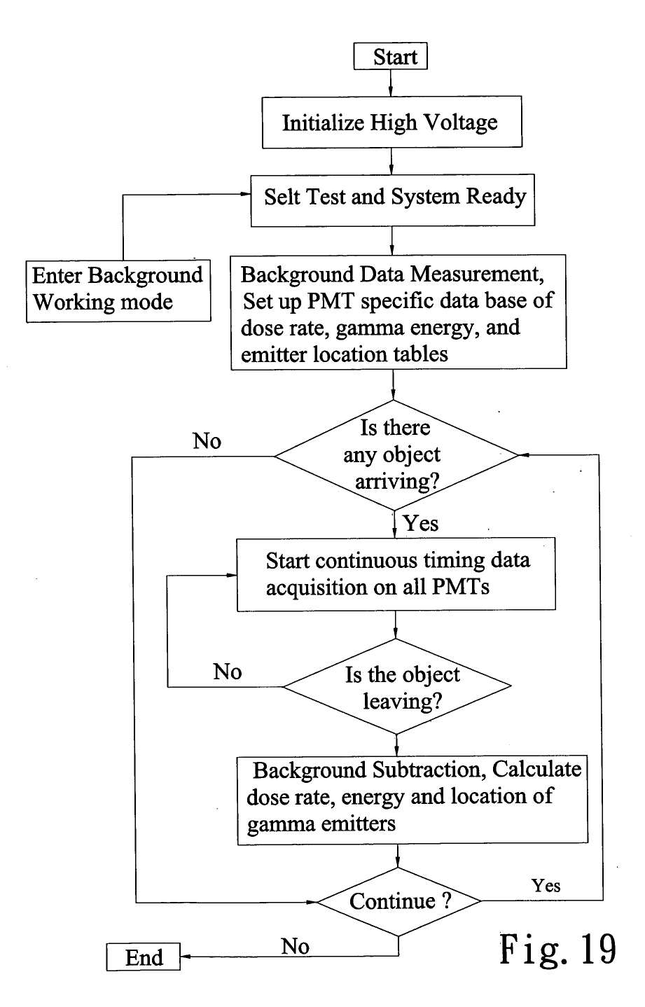

The main controller of gate monitoring system of the present invention has the following functions:
1. Set up and calibration: Firstly, system should be set up as shown in FIG. 8, then, as have been described above, we build up correlation tables by calibration with respect to selected gamma sources.
2. Data acquisition: After a complete system has been set up and calibrated, the absolute timing records of all PMTs were collected in sync. with each other by the method of buffered semi-period timing.
3. Data analysis: When the limit of data size or collection time is reached, the computer begins to analyze and calculate the counting rate, the pulse width and time of coincidence distribution characteristics. Type and distribution of gamma emitters within the detected objects can be estimated and cross-checked from the data by consulting three different correlation tables.
4. Display: After the analysis results have been confirmed, the surface dose rate, type and distribution of the gamma emitters of the measured objects can be displayed and alarms given, if any, in a form demanded by the requirements of radiation protection and safety.
5. Data storage and communication: In order to build up database of the passing objects in the gate monitoring system and the retrieval of the measured data, the main controller must be able to link other computers for data transfer and record. The flowchart of the controller software is shown in FIG. 19.

The foregoing description of the preferred embodiments of the present invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

What is claimed is:

1. A gate radiation monitoring system for instant gamma analysis on passing by objects including:
at least two column shape plastic scintillation detectors standing opposite each other and working at pulse counting mode;
a voltage supply circuit for plastic scintillation detector and photomultiplier tube (PMT), and a lower limit discrimination circuit for shaping radiation pulse signal, filtering noise and converting photomultiplier tube signal into logic pulse;
an electronic device for continuous buffered semi-period timing on all PMT signals;
a main controller consisting of a computer with build-in programs and peripheral hardware for the operation, input, display, communication of the data; and
a set of operation software for implementing the calculation of the counting rate, the pulse width distribution characteristics, and the time of coincident distribution to determine the type and location of the gamma emitters when the preset limit of number or time of data measured by continuously buffered semi-period timing has been reached.

2. The gate radiation monitoring system for instant gamma analysis on passing by objects as claimed in claim 1, wherein the two ends of the column plastic scintillation detector are respectively provided with photomultiplier tubes, and their working mode are: the conversion of pulse is one to one; the detection area is maximized by the suitable design of the size of the plastic scintillation detector, the distance between the two plastic scintillation detectors, and the shape of the gate for cars or people; the factors such as the material of plastic scintillation detector, the spectrum efficiency of the photomultiplier, the surface treatment for reflection, the volume efficiency, etc. must be considered to accomplish an efficient absorption and electrical conversion for the detection of γ and X rays, and to shield and reduce the interference from ambient α or β rays.

3. The gate radiation monitoring system for instant gamma analysis on passing by objects as claimed in claim 1, wherein the voltage supply circuit and lower limit discrimination circuit provide suitable voltage for photomultiplier tube to implement the signal conversion of light photon pulse from the plastic scintillation detector and to amplify and shape the pulse signals from the plastic scintillation detectors, to filter noise and convert the light photon pulse into logic pulse.

4. The gate radiation monitoring system for instant gamma analysis on passing by objects as claimed in claim 1, wherein the electronic device for continuous buffered semi-period timing is used to timing the logic signal of all PMTs from the lower limit discrimination circuit with a precise high frequency clock, and store counts into corresponding buffer memory sequentially every semi period, after the limit of number and time are reached, the computer then analyzes the record data to get the count rate, the pulse width distribution characteristics and time of coincidence distributions to provide them for gamma property calculations.

5. The gate radiation monitoring system for instant gamma analysis on passing by objects as claimed in claim 1, wherein the main controller of computer and peripheral hardware has a counter and digital interface array for the control and data acquisition of plastic scintillation detectors; it can measure the characteristics of the radiation field from the digital logic signals by synchronous sampling of multiple PMT signals by buffered semi-period timing method; and it has the standard functions such as mathematic manipulation, storage, display and data transfer so that it can perform statistic analysis about the counting rate, the pulse width distribution characteristics, and the time of coincidence distributions.

6. A gate radiation monitoring method using the gate radiation monitoring system as claimed in claim 1, including the following steps:
(a) calibrating detectors and establishing work parameters;
(b) connecting system components: plastic scintillation detector, voltage supply, lower limit discrimination circuits, and electronic device for continuous buffered semi-period timing, and by means of the standard radiation source for calibration, obtaining the correlation table of coordinate versus counting rate, pulse width distribution characteristics, and time of coincidence distributions from all four photomultiplier tubes;
(c) initiating program and getting detector data:
after system setup, initiate the operation programs and set the work parameters of all components by way of the digit to analog conversion interface, then start the continuous buffered semi-period timing and collecting the data from all PMTs;
(d) identifying the type and location of the gamma emitters:
when the preset limit of number or time has been reached, the operation software of main controller begins calculations on the count rate, the pulse width distribution characteristics and the time of coincidence distribution, and applying built-in correlation tables to get the best estimation about type and location of the gamma emitters;
(e) displaying the result and alarm:
when the gamma analysis results are confirmed, the surface dose rate, type and distribution of the gamma emitters of the measured objects be displayed and alarms given, if any, in a form demanded by the requirements of radiation protection and safety;
(f) data storage and communication: in order to build up database of the passing objects in the gate monitoring system and the retrieval of the measured data, the main controller must be able to link other computers for data transfer and record;
(g) repeating the above steps, when people and vehicles passing the gate radiation monitoring system, both type and location of radiations being continuously measured and deduced, and implementing data record, transfer, display and giving an alarm according to the predetermined working parameters, unless shut down being required.
